(19) United States
(12) Patent Application Publication
(10) Pub. No.: US 2026/0112952 A1
(43) Pub. Date: Apr. 23, 2026

(54) METHOD FOR PRODUCING ROTARY ELECTRICAL MACHINE, AND ROTARY ELECTRICAL MACHINE

(71) Applicant: KABUSHIKI KAISHA TOSHIBA, Kawasaki-shi (JP)

(72) Inventors: Masakazu KIKAWADA, Yokohama (JP); Tomoki TSUKADA, Yokohama (JP)

(73) Assignee: KABUSHIKI KAISHA TOSHIBA, Kawasaki-shi (JP)

(21) Appl. No.: 19/429,095

(22) Filed: Dec. 22, 2025

Related U.S. Application Data
(63) Continuation of application No. PCT/JP2023/029528, filed on Aug. 15, 2023.

(51) Int. Cl. H02K 15/047; H02K 3/04

(52) U.S. Cl. CPC H02K 15/047; H02K 3/04

(57) ABSTRACT

A method for producing a rotary electrical machine according to an embodiment includes a process of disposing a segment in each of multiple slots located in a core in which the segment includes a first conductor part and a first insulating part, a process of disposing a terminal at the core, in which the terminal includes a second conductor part and a second insulating part, a process of forming a coil located in the slots by laser-welding end parts of an adjacent pair of the first conductor part, and a process of laser-welding a plate-shaped bus bar to an end part of the second conductor part. The bus bar has a hole extending through the bus bar in a thickness direction. The process of laser-welding the bus bar includes inserting the end part of the second conductor part into the hole of the bus bar.

### CROSS-REFERENCE TO RELATED APPLICATIONS

This application is based upon and claims the benefit of priority from the PCT Patent Application PCT/JP2023/029528, filed on August 15, 2023; the entire contents of which are incorporated herein by reference.

### FIELD

Embodiments of the invention relate to a method for producing a rotary electrical machine, and a rotary electrical machine.

### BACKGROUND

For example, a coil that is wound onto a core is included in a rotary electrical machine such as a motor, a generator, etc. The coil is formed by winding a copper wire multiple times, and therefore has poor flexibility. Therefore, the ease of work is markedly poor when a coil formed by winding a copper wire multiple times is inserted into slots of the core. Therefore, technology has been proposed in which a coil that is wound onto the core is formed by inserting multiple segments into the slots, and then irradiating a laser light on the end part of a segment and the end part of an adjacent segment to weld the end parts to each other.

Also, in such a coil, a terminal for applying power to the coil and a terminal connected to a neutral point of the coil are electrically connected. In such a case, the terminal for applying the power and the terminal connected to the neutral point are formed using the same material as the segment (e.g., a rectangular wire).

Also, a bus bar is welded to the terminal for applying the power. Also, the terminal for applying the power is electrically connected to a control circuit, etc., located outside the rotary electrical machine via the bus bar. A bus bar also is welded to the terminal connected to the neutral point of the coil. Also, the terminal connected to the neutral point is electrically connected to a control circuit, etc., via the bus bar.

Here, it is necessary to position the terminal and the bus bar when welding the terminal and the bus bar. Typically, a welding jig is used to position the terminal and the bus bar. However, there are members such as segments and the like proximate to the terminal, and so depending on the terminal arrangement, etc., there are cases where the shape of the welding jig becomes complex, and it is difficult to detach the welding jig. Also, there are cases where the shape of the bus bar becomes complex, and the welding of the bus bar and the terminal is more difficult than the welding of the segment end parts to each other.

It is therefore desirable to develop technology that can easily weld the bus bar and the terminal.

### BRIEF DESCRIPTION OF THE DRAWINGS

FIG. 1 is a schematic perspective view illustrating a stator.

FIG. 2 is a schematic perspective view illustrating the stator.

FIG. 3 is a process drawing illustrating a formation process of a segment.

FIG. 4 is a schematic view illustrating the segment.

FIG. 5 is a schematic perspective view illustrating a member.

FIG. 6 is a schematic perspective view illustrating the formation of the member.

FIG. 7 is a schematic view illustrating the formation of a coil.

FIG. 8 is a process drawing illustrating a procedure of welding a bus bar to end parts of terminals.

FIG. 9 is a process drawing illustrating the procedure of welding the bus bar to the end parts of the terminals.

FIG. 10 is a process drawing illustrating the procedure of welding the bus bar to the end parts of the terminals.

FIG. 11 is a process drawing illustrating a welding procedure of a bus bar according to another embodiment.

FIG. 12 is a process drawing illustrating the welding procedure of the bus bar according to the other embodiment.

FIG. 13 is a process drawing illustrating the welding procedure of the bus bar according to the other embodiment.

FIG. 14 is a process drawing illustrating a welding procedure of a bus bar according to another embodiment.

FIG. 15 is a process drawing illustrating the welding procedure of the bus bar according to the other embodiment.

FIG. 16 is a process drawing illustrating the welding procedure of the bus bar according to the other embodiment.

FIG. 17 is a schematic perspective view illustrating a member.

FIG. 18 is a schematic perspective view illustrating the formation of the member.

### DETAILED DESCRIPTION

For example, a method for producing a rotary electrical machine according to the embodiment can be used in the production of a rotary electrical machine such as a motor, a generator, etc. As an example below, a case will be described where the method for producing the rotary electrical machine according to the embodiment is used to produce a stator. However, the method for producing the rotary electrical machine according to the embodiment also can be used to produce other rotary electrical machines.

A method for producing a rotary electrical machine according to an embodiment includes a process of disposing a segment in each of multiple slots located in a core in which the segment includes a first conductor part and a first insulating part located at an outer surface of the first conductor part, a process of disposing a terminal at the core, in which the terminal includes a second conductor part and a second insulating part located at an outer surface of the second conductor part, a process of forming a coil located in the slots by laser-welding end parts of an adjacent pair of the first conductor part, and a process of laser-welding a plate-shaped bus bar to an end part of the second conductor part. The bus bar has a hole extending through the bus bar in a thickness direction. The process of laser-welding the bus bar includes inserting the end part of the second conductor part into the hole of the bus bar.

Embodiments will now be illustrated with reference to the drawings. Similar components in the drawings are marked with the same reference numerals; and a detailed description is omitted as appropriate.

First, a stator 1 produced using the method for producing the rotary electrical machine according to the embodiment will be described.

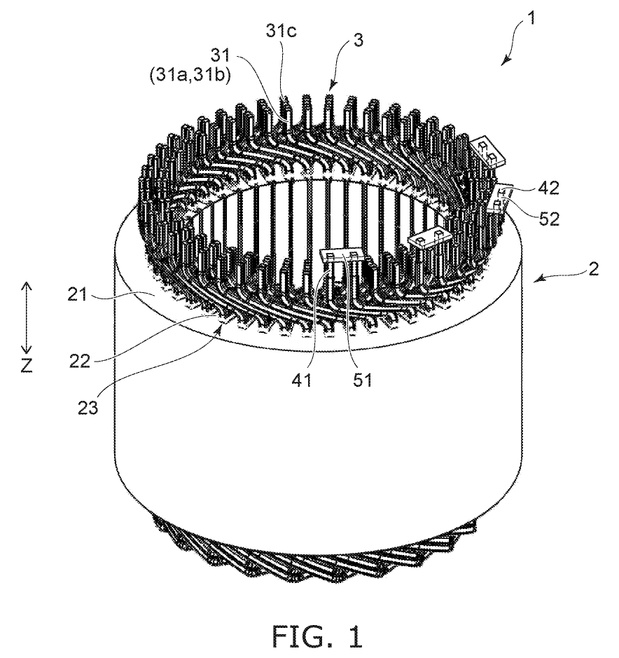

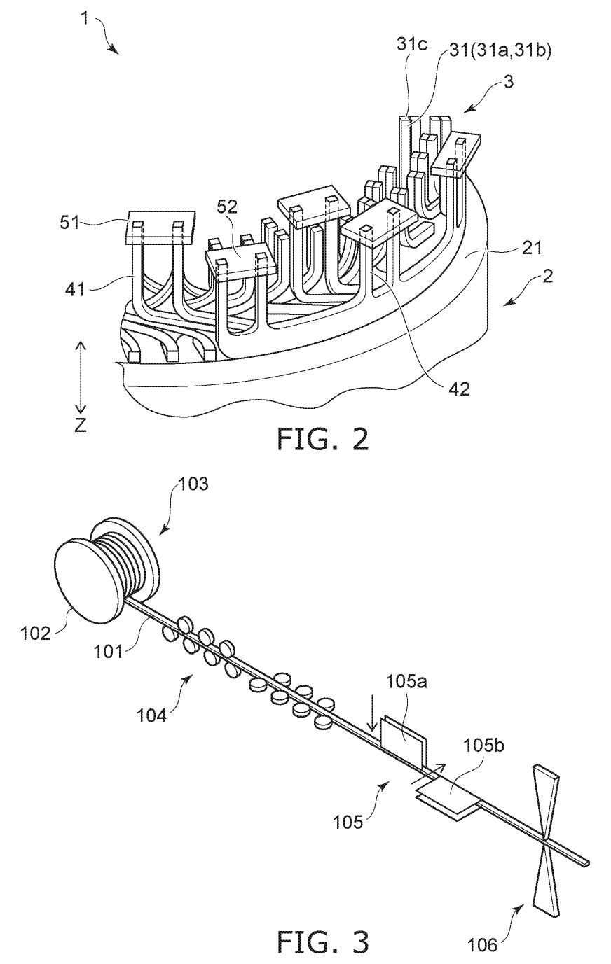

FIGS. 1 and 2 are schematic perspective views illustrating the stator 1.

As shown in FIGS. 1 and 2, the stator 1 includes a core 2, a coil 3, a terminal 41, a terminal 42, a bus bar 51, and a bus bar 52.

The core 2 includes, for example, multiple ring-shaped magnetic members stacked in the axis direction of the stator 1 (in FIG. 1, a Z-direction). For example, the magnetic member is formed from an electrical steel sheet (a silicon steel sheet). The core 2 includes a yoke 21 and multiple teeth 22. The yoke 21 is tubular and is positioned at the outer circumference side of the core 2. The multiple teeth 22 are located at the inner circumferential surface of the yoke 21 at uniform spacing. Each of the multiple teeth 22 protrudes from the inner circumferential surface of the yoke 21 toward the center of the core 2 and extends in the axis direction of the stator 1. Also, a groove that is located between the tooth 22 and the tooth 22 is used as a slot 23. The shapes, number, and sizes of the teeth 22 are not limited to those illustrated and can be modified as appropriate according to the application, size, specifications, etc., of the rotary electrical machine including the stator 1.

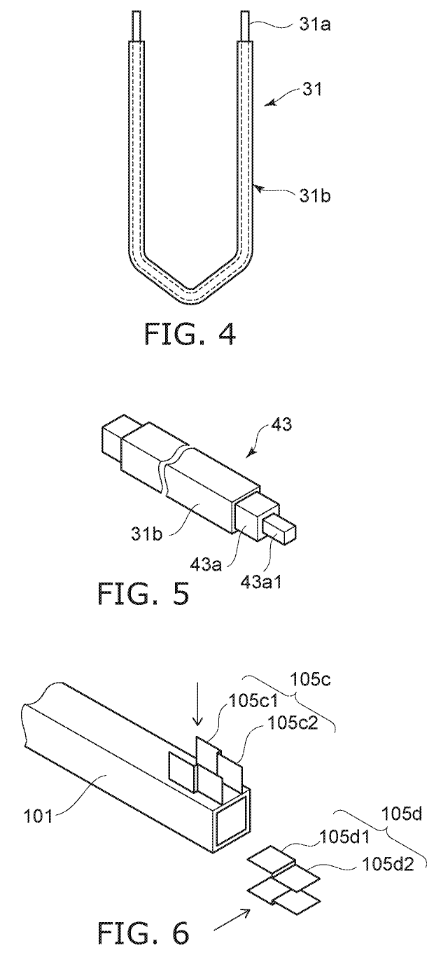

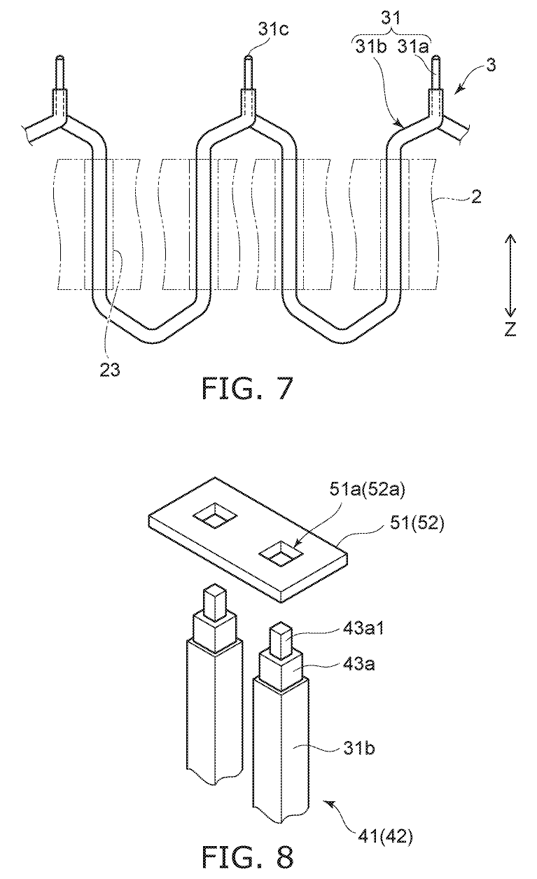

The coil 3 includes multiple segments 31. The segment 31 includes a conductor part 31a (corresponding to an example of a first conductor part) and an insulating part 31b (corresponding to an example of a first insulating part) (see, e.g., FIGS. 4 and 7). The conductor part 31a is substantially U-shaped and is formed from a material having a high conductivity. For example, the conductor part 31a is formed from so-called pure copper or a material having copper as a major component. For example, the conductor part 31a is formed from a rectangular wire. The rectangular wire is a wire having a quadrilateral cross-sectional shape. The insulating part 31b covers the outer surface of the conductor part 31a. However, the insulating part 31b is not provided and the conductor part 31a is exposed proximate to the two end parts of the conductor part 31a. The insulating part 31b includes, for example, enamel, etc.

The end parts of an adjacent pair of conductor parts 31a are laser-welded to each other. One coil 3 is formed by connecting the multiple segments 31 via a weld part 31c. Also, an insulating part that covers the exposed portion of the conductor part 31a and the weld part 31c can be included.

Multiple coils 3 are arranged. The multiple coils 3 can be arranged in the radial direction of the core 2 (a direction that passes through the central axis of the core 2 and is orthogonal to the Z-direction). For example, two coils 3 can be included as illustrated in FIG. 1. The exterior shapes, numbers, sizes, etc., of the coil 3 and the segments 31 are not limited to those illustrated, and can be modified as appropriate according to the application, size, specifications, etc., of the rotary electrical machine including the stator 1. For example, three coils 3 or four coils 3 may be arranged in the radial direction of the core 2.

The terminal 41 is electrically connected to one coil 3. For example, the terminal 41 is provided to apply power to the coil 3. The terminal 42 is electrically connected to the neutral point of the multiple coils 3. As described below, for example, the terminal 41 and the terminal 42 can be formed using the same material as the segment 31. Thus, the segment 31, the terminal 41, and the terminal 42 can be produced in the same process, which can reduce the production cost, reduce the production delivery time, etc.

The bus bar 51 is plate-shaped and is welded to the end part of the terminal 41. The terminal 41 is electrically connected to a control circuit or the like located outside the stator 1 via the bus bar 51.

The bus bar 52 is plate-shaped and is welded to the end part of the terminal 42. The terminal 42 is electrically connected to the control circuit or the like located outside the stator 1 via the bus bar 52.

The bus bar 51 and the bus bar 52 are formed from materials having high conductivity. For example, the bus bar 51 and the bus bar 52 are formed from so-called pure copper or a material having copper as a major component.

Although the bus bar 51 and the bus bar 52 having quadrilateral planar shapes are illustrated as an example, the planar shapes of the bus bars 51 and 52 can be modified as appropriate according to the arrangement of the terminals 41 and 42, etc.

In the case of the stator 1 illustrated in FIGS. 1 and 2, the bus bar 51 and the bus bar 52 extend in directions toward the outer side of the core 2 in the radial direction of the core 2. However, the directions in which the bus bar 51 and the bus bar 52 extend can be modified as appropriate according to the arrangement of the segment 31, the terminal 41, and the terminal 42, etc. In other words, for example, the bus bar 51 and the bus bar 52 may extend in directions toward at least one of the inner side of the core 2 and the outer side of the core 2 in the radial direction of the core 2.

A case where the method for producing the rotary electrical machine according to the embodiment is used to produce the stator 1 will now be described.

First, the core 2 is formed. For example, multiple plate-shaped magnetic members including portions used to form the yoke 21 and the multiple teeth 22 are formed. For example, the magnetic member can be formed by stamping an electrical steel sheet having a thickness of about 0.05 mm to 1.0 mm. Then, the core 2 is formed by, for example, stacking the multiple magnetic members and welding or caulking the multiple magnetic members. The core 2 also can be formed by press forming a magnetic material powder and a resin binder.

Also, multiple segments 31 are formed as components of the coil 3.

FIG. 3 is a process drawing illustrating a formation process of the segment 31.

First, a wire-shaped material 101 is formed by applying a coating including enamel, etc., on the outer surface of a rectangular wire. The wire-shaped material 101 that is formed is wound onto a reel 102.

As shown in FIG. 3, the reel 102 on which the wire-shaped material 101 is wound is set at a supply part 103.

Then, a wire drawing machine 104 draws the wire-shaped material 101 wound onto the reel 102 from the reel 102 and forms the wire-shaped material 101 into a linear shape.

Then, the coating in a partial region of the wire-shaped material 101 is stripped away by a stripping machine 105. The stripping machine 105 includes, for example, a cutter 105a including a pair of parallel blades, and a cutter 105b including a pair of parallel blades. The cutter 105a and the cutter 105b each strip away the coating along a pair of surfaces of the rectangular wire included in the wire-shaped material 101. In such a case, the movement direction of the cutter 105b is orthogonal to the movement direction of the cutter 105a. Therefore, the coating that is adhered to four side surfaces of the rectangular wire can be partially stripped away by the cutters 105a and 105b.

Then, the wire-shaped material 101 is cut to a prescribed length by a cutting machine 106. The rectangular wire is exposed from under the coating proximate to the two end parts of the wire-shaped material 101 cut to the prescribed length.

Continuing, the wire-shaped material 101 that is cut to the prescribed length is bent to form the segment 31.

FIG. 4 is a schematic view illustrating the segment 31.

As shown in FIG. 4, the segment 31 is, for example, substantially U-shaped. The segment 31 includes, for example, the conductor part 31a and the insulating part 31b. The conductor part 31a is formed by the cutting machine 106 cutting the rectangular wire included in the wire-shaped material 101. The insulating part 31b is the coating applied to the rectangular wire. A portion proximate to the end part of the segment 31 at which the conductor part 31a is exposed from under the insulating part 31b is the portion at which the coating is partially stripped away by the stripping machine 105.

Thus, multiple segments 31 are formed.

Also, the terminal 41 and the terminal 42 are formed. The terminal 41 and the terminal 42 can be formed by bending a wire-shaped member 43 into a prescribed shape.

FIG. 5 is a schematic perspective view illustrating the member 43.

As shown in FIG. 5, the member 43 includes a conductor part 43a (corresponding to an example of a second conductor part) and the insulating part 31b (corresponding to an example of a second insulating part). The member 43 can be formed using the wire-shaped material 101 described above. Therefore, the cross-sectional shape and the cross-sectional dimensions in a direction orthogonal to the direction in which the conductor part 43a extends can be the same as the cross-sectional shape and the cross-sectional dimensions in a direction orthogonal to the direction in which the conductor part 31a extends. The vicinities of the two end parts of the conductor part 43a are exposed from under the insulating part 31b.

A stepped part 43a1 is located at one end part of the conductor part 43a. The cross-sectional dimensions of the stepped part 43a1 in a direction orthogonal to the direction in which the conductor part 43a extends are less than the cross-sectional dimensions of the conductor part 43a. A laser light is irradiated on the end part of the stepped part 43a1 when welding the bus bar 51 to the terminal 41 and when welding the bus bar 52 to the terminal 42. Details of the welding of the bus bars 51 and 52 are described below.

The member 43 can be formed from the wire-shaped material 101 described above by providing a cutter 105c and a cutter 105d in the stripping machine 105 described above.

FIG. 6 is a schematic perspective view illustrating the formation of the member 43.

As shown in FIG. 6, a pair of cutters 105c are included. The cutter 105c includes a blade 105c1 that strips away the coating in a partial region of the wire-shaped material 101, and a blade 105c2 that notches a portion of the rectangular wire included in the wire-shaped material 101.

A pair of cutters 105d is included. The cutter 105d includes a blade 105d1 that strips away the coating in a partial region of the wire-shaped material 101, and a blade 105d2 that notches a portion of the rectangular wire included in the wire-shaped material 101. The blade 105d1 can be the same as the blade 105c1. The blade 105d2 can be the same as the blade 105c2.

The movement direction of the cutter 105d is orthogonal to the movement direction of the cutter 105c. Therefore, the cutter 105c and the cutter 105d can partially strip away the coating adhered to the four side surfaces of the rectangular wire and form the stepped part 43a1 in the rectangular wire.

Although a case is illustrated where four side surfaces of the rectangular wire are notched, two side surfaces of the rectangular wire or three side surfaces of the rectangular wire may be notched.

The coating that is adhered to the portion at the other end part of the member 43 (the portion to which the coil 3 is welded) may be stripped away by the cutters 105a and 105b described above.

The cutter 105a and the cutter 105b can be provided in the same stripping machine 105 as the cutters 105c and 105d, or can be provided in a different stripping machine 105.

The wire-shaped material 101 in which the stepped part 43a1 is formed and the coating is partially stripped away is cut to a prescribed length by the cutting machine 106 described above. The member 43 illustrated in FIG. 5 is formed by cutting such a wire-shaped material 101.

The terminal 41 and the terminal 42 can be formed by bending the wire-shaped member 43 into a prescribed shape.

The numbers of the terminals 41 and 42 are less than the number of the segments 31. Therefore, if the segment 31, the terminal 41, and the terminal 42 can be formed from the same material (the wire-shaped material 101) in the same production line, the productivity can be increased, which in turn reduces the production cost, reduces the production delivery time, etc.

Then, the coil 3 is formed by laser-welding the end parts of the multiple segments 31 to each other. FIG. 7 is a schematic view illustrating the formation of the coil 3.

First, as shown in FIG. 7, the multiple segments 31 are located in the multiple slots 23 located in the core 2. For example, each of the multiple segments 31 are inserted into the prescribed slots 23 from the axis direction of the core 2 (in FIG. 7, the Z-direction). In such a case, one segment 31 is inserted to straddle multiple slots 23. For example, a so-called distributed winding coil 3 can be formed. Also, a so-called wave winding coil 3 can be formed. Also, an insulation paper that covers the segment 31 can be provided in each of the multiple slots 23.

Continuing, the portion of the segment 31 protruding from the core 2 is bent in a direction toward the adjacent segment 31. Then, furthermore, the vicinity of the portion of the conductor part 31a exposed from under the insulating part 31b is bent in the axis direction of the core 2 (in FIG. 7, the Z-direction). Also, the portion of the conductor part 31a exposed from under the insulating part 31b and the portion of the adjacent conductor part 31a exposed from under the insulating part 31b are arranged at positions overlapping each other in the circumferential direction of the core 2.

Then, by repeatedly performing the procedure described above, multiple sets of the multiple segments 31 arranged in the circumferential direction of the core 2 are arranged in the radial direction of the core 2.

Although a case is illustrated where the bending is performed after mounting the multiple segments 31 in the slots 23, the bending is not limited thereto. For example, the bending of the multiple segments 31 can be performed, and each of the multiple segments 31 on which the bending is performed can be mounted in the prescribed slots 23. In such a case, the segment 31 on which the bending is performed can be mounted outward from the inner side of the core 2.

Here, if a gap is present between the end parts of the segments 31 (the conductor parts 31a) when laser-welding the end parts of the segments 31 (the conductor parts 31a) to each other, there is a risk that the welding cross-sectional area may be reduced, the laser light may leak through the gap between the end parts, and the insulating part 31b may be damaged. Therefore, when laser-welding, a welding jig can be used to cause the end parts of the pair of conductor parts 31a adjacent to each other in the radial direction of the core 2 to approach each other.

Also, the vicinities of the end parts of the adjacent pair of conductor parts 31a can be cut to make positions of the end surfaces of the pair of conductor parts 31a uniform. If the positions of the end surfaces of the pair of conductor parts 31a are uniform, it is easy for the positions of the end surfaces of the pair of conductor parts 31a to be within the range of the depth of focus when laser-welding.

Continuing, the coil 3 that is located in the slots 23 is formed by laser-welding the end parts of the adjacent segments 31 (the conductor parts 31a) to each other. The weld part 31c is formed at the end parts of the laser-welded conductor part 31a. One coil 3 is formed by connecting the multiple segments 31 (the conductor parts 31a) in series via the weld parts 31c. Also, the multiple coils 3 that are arranged in the radial direction of the core 2 are formed.

Also, the terminal 41 and the terminal 42 are located at the core 2; and the end parts of the terminals 41 and 42 at the sides opposite to the sides at which the stepped parts 43a1 are formed are welded to the coil 3. The terminal 41 is electrically connected to the end part of one coil 3. The terminal 41 is a terminal for applying the power to the coil 3. The terminal 42 is electrically connected to the neutral point of the multiple coils 3. The terminal 42 is a terminal for electrically connecting the multiple coils 3 to the neutral point of a control circuit, etc. For example, the terminal 41 and the terminal 42 can be welded by laser-welding.

Then, the bus bar 51 is welded to the end part of the terminal 41 at the side at which the stepped part 43a1 is formed.

Also, the bus bar 52 is welded to the end part of the terminal 42 at the side at which the stepped part 43a1 is formed.

FIGS. 8 to 10 are process drawings illustrating a procedure of welding the bus bar 51 (the bus bar 52) to the end part of the terminal 41 (the terminal 42).

As shown in FIG. 8, the bus bar 51 (the bus bar 52) is plate-shaped and has a hole 51a (a hole 52a) extending through the bus bar 51 (the bus bar 52) in the thickness direction. The shape of the hole 51a (the hole 52a) can be the same as the cross-sectional shape of the conductor part 43a of the terminal 41 (the terminal 42). The dimensions of the hole 51a (the hole 52a) can be equal to the cross-sectional dimensions of the conductor part 43a or slightly greater than the cross-sectional dimensions of the conductor part 43a.

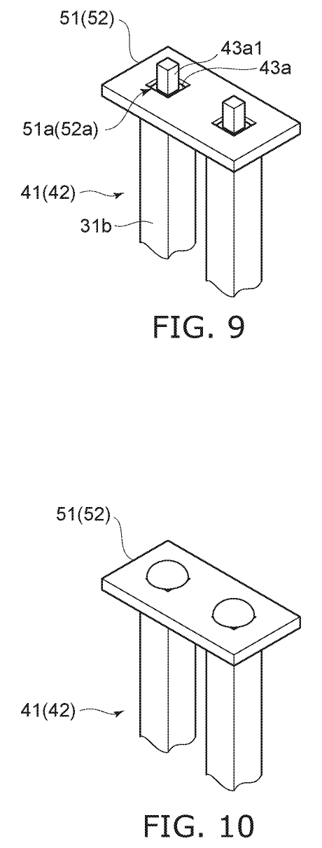

First, as shown in FIG. 9, the conductor part 43a of the terminal 41 (the terminal 42) is inserted into the hole 51a (the hole 52a). When the conductor part 43a is inserted into the hole 51a (the hole 52a), the stepped part 43a1 protrudes from the bus bar 51 (the bus bar 52).

Continuing as shown in FIG. 10, the terminal 41 (the terminal 42) and the bus bar 51 (the bus bar 52) are welded by irradiating a laser light on the end part of the stepped part 43a1 protruding from the bus bar 51 (the bus bar 52).

Here, it also may be considered to laser-weld the bus bar to the side surface of the conductor part 43a of the terminal 41 (the terminal 42). If, however, the bus bar is laser-welded to the side surface of the conductor part 43a, it becomes easier for the laser light to be incident on the insulating part 31b, and so the insulating part 31b is easily damaged. Also, because the coil 3 (the segments 31) are present around the terminal 41 (the terminal 42), it may be difficult to irradiate the laser light; and the jig and/or cover used in the laser welding may become complex.

In contrast, when the laser light is irradiated on the end part of the terminal 41 (the terminal 42) protruding from the plate-shaped bus bar 51 (bus bar 52), the periphery of the terminal 41 (the terminal 42) is covered with the bus bar 51 (the bus bar 52), and so damage of the insulating part 31b of the terminal 41 (the terminal 42) can be suppressed.

Also, the alignment of the bus bar 51 (the bus bar 52) and the terminal 41 (the terminal 42) can be performed by inserting the conductor part 43a of the terminal 41 (the terminal 42) into the hole 51a of the bus bar 51 (the hole 52a of the bus bar 52). In other words, the bus bar 51 (the bus bar 52) can perform the role of a welding cover and a welding jig.

Furthermore, the irradiation direction of the laser light when welding the bus bar 51 (the bus bar 52) is the same as the irradiation direction of the laser light when welding the end parts of the segments 31 to each other. It is therefore easy to weld the bus bar 51 (the bus bar 52) following the welding of the end parts of the segments 31 to each other. Therefore, the production processes can be simplified, the production period can be reduced, the production cost can be reduced, etc.

Then, the multiple coils 3, the terminal 41, and the terminal 42 are fixed to the core 2. For example, varnish is supplied to the gap between the core 2 and the coil 3, the terminal 41, and the terminal 42; and the multiple coils 3, the terminal 41, and the terminal 42 are fixed to the core 2 by curing the varnish.

Also, an insulating part can be formed by, for example, supplying varnish to the weld parts and the portions of the coil 3, the terminal 41, and the terminal 42 at which the conductor part 31a is exposed.

If varnish is adhered to the end part, the outer part, the inner part, etc., of the core 2 when supplying varnish, for example, the varnish can be removed by irradiating a laser light on the adhered varnish.

Thus, the stator 1 can be produced.

Welding of the bus bar 51 (the bus bar 52) according to another embodiment will now be described.

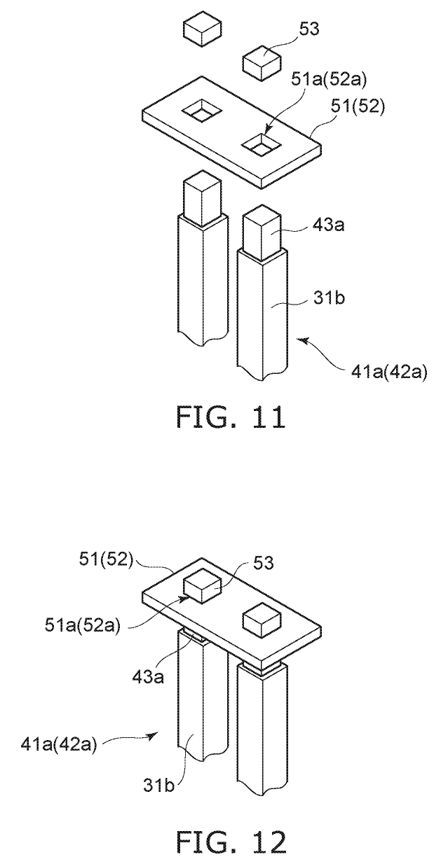

FIGS. 11 to 13 are process drawings illustrating a welding procedure of the bus bar 51 (the bus bar 52) according to the other embodiment.

As shown in FIG. 11, a terminal 41a (a terminal 42a) includes the conductor part 43a and the insulating part 31b. The terminal 41a corresponds to the terminal 41 described above. The terminal 42a corresponds to the terminal 42 described above.

However, the terminal 41a (the terminal 42a) does not include the stepped part 43a1. In other words, the terminal 41a (the terminal 42a) can be formed by omitting the stepped part 43a1 from the terminal 41 (the terminal 42). For example, such a terminal 41a (terminal 42a) can be produced similarly to the segment 31.

Also, as shown in FIG. 11, a pea-shaped welding consumable 53 is used when welding the bus bar 51 (the bus bar 52) and the terminal 41a (the terminal 42a). In such a case, it is favorable for the material of the welding consumable 53 to be the same as the material of the conductor part 43a and the bus bar 51 (the bus bar 52). As described above, the vicinities of the end parts of the adjacent pair of conductor parts 31a are cut before laser-welding the end parts of the segments 31 (the conductor parts 31a) to each other. The material of the conductor part 31a can be the same as the material of the conductor part 43a and the bus bar 51 (the bus bar 52). Therefore, the welding consumable 53 can be the end piece made when the vicinity of the end part of the conductor part 31a is cut. Thus, the production cost can be reduced.

First, as shown in FIG. 12, the conductor part 43a of the terminal 41a (the terminal 42a) is inserted into the hole 51a (the hole 52a). Then, the welding consumable 53 is placed at the opening of the hole 51a (the hole 52a) at the side opposite to the side into which the conductor part 43a is inserted.

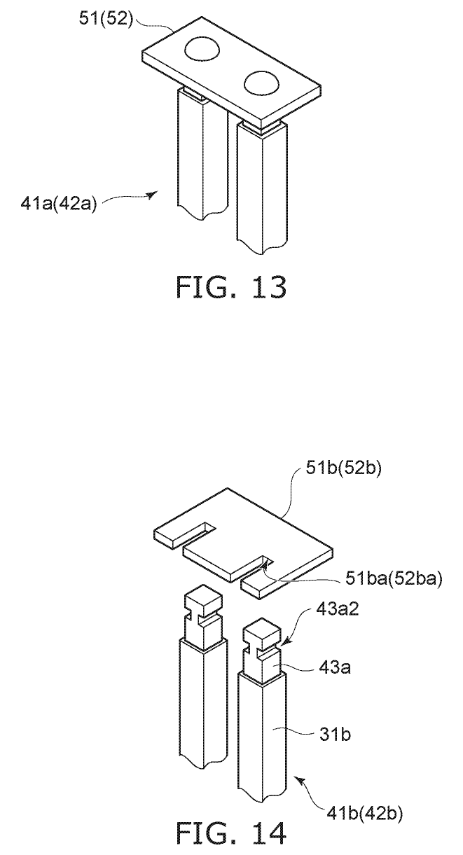

Continuing as shown in FIG. 13, the terminal 41a (the terminal 42a) and the bus bar 51 (the bus bar 52) are welded by irradiating a laser light on the welding consumable 53.

According to the embodiment as well, the bus bar 51 (the bus bar 52) can perform the role of a welding cover. Therefore, damage of the insulating part 31b can be suppressed. Also, the bus bar 51 (the bus bar 52) can perform the role of a welding jig. It is therefore easy to weld the bus bar 51 (the bus bar 52) and the terminal 41a (the terminal 42a). Also, the stepped part 43a1 can be omitted, and so the terminal 41a (the terminal 42a) can be formed in the same process as the segment 31. Therefore, the production cost can be reduced, the production period can be reduced, etc.

FIGS. 14 to 16 are process drawings illustrating a welding procedure of a bus bar 51b (a bus bar 52b) according to another embodiment.

The bus bar 51b corresponds to the bus bar 51 described above. The bus bar 52b corresponds to the bus bar 52 described above. For example, the material of the bus bar 51b (the bus bar 52b) can be the same as the material of the bus bar 51 (the bus bar 52).

As shown in FIG. 14, the bus bar 51b (the bus bar 52b) is plate-shaped and has a hole 51ba (a hole 52ba) extending through the bus bar 51b (the bus bar 52b) in the thickness direction. The hole 51ba (the hole 52ba) extends through the bus bar 51b (the bus bar 52b) in the thickness direction. Also, for example, the hole 51ba (the hole 52ba) is open at one side of the bus bar 51b (the bus bar 52b).

Although the bus bar 51b (the bus bar 52b) that has a quadrilateral planar shape is illustrated as an example, the planar shape of the bus bar 51b (the bus bar 52b) can be modified as appropriate according to the arrangement of a terminal 41b (a terminal 42b), etc.

The terminal 41b (the terminal 42b) includes the conductor part 43a and the insulating part 31b. The terminal 41b corresponds to the terminal 41 described above. The terminal 42b corresponds to the terminal 42 described above.

However, the terminal 41b (the terminal 42b) does not include the stepped part 43a1. Also, a pair of grooves 43a2 is located proximate to the end part of the conductor part 43a. The pair of grooves 43a2 is opposite each other with the central axis of the conductor part 43a interposed. The distance between the bottom surfaces of the pair of grooves 43a2 is equal to or slightly less than the width dimension of the hole 51ba (the hole 52ba) of the bus bar 51b (the bus bar 52b). The height dimension of a groove 43a2 is equal to or slightly greater than the thickness of the bus bar 51b (the bus bar 52b).

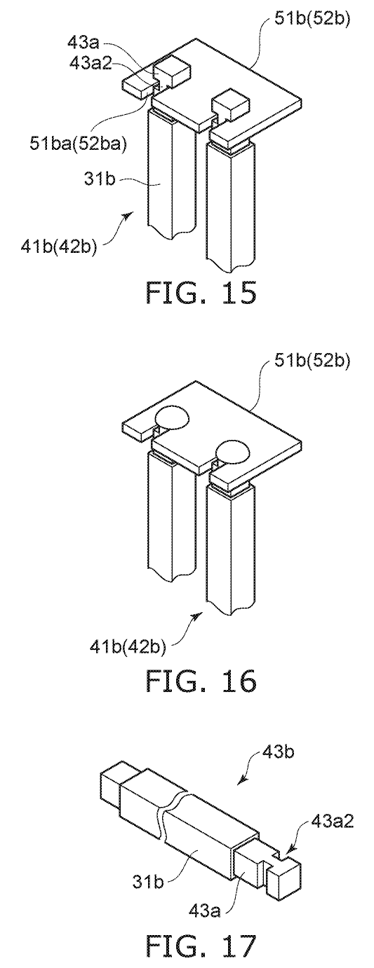

Therefore, as shown in FIG. 15, the portion of the conductor part 43a in which the pair of grooves 43a2 is located can be disposed in the hole 51ba (the hole 52ba) of the bus bar 51b (the bus bar 52b). In such a case, the portion of the conductor part 43a in which the pair of grooves 43a2 is located is inserted into the hole 51ba (the hole 52ba) from one side of the bus bar 51b (the bus bar 52b).

When the portion of the conductor part 43a in which the pair of grooves 43a2 is located is inserted into the hole 51ba (the hole 52ba), the end part of the conductor part 43a protrudes from the bus bar 51b (the bus bar 52b).

Continuing as shown in FIG. 16, the terminal 41b (the terminal 42b) and the bus bar 51b (the bus bar 52b) are welded by irradiating a laser light on the end part of the conductor part 43a protruding from the bus bar 51b (the bus bar 52b).

According to the embodiment, the portion in which the pair of grooves 43a2 is located in the conductor part 43a is located inside the hole 51ba (the hole 52ba), and so the bonding strength between the terminal 41b (the terminal 42b) and the bus bar 51b (the bus bar 52b) can be increased. Therefore, the reliability related to the electrical connection between the terminal 41b (the terminal 42b) and the bus bar 51b (the bus bar 52b) can be increased.

Also, the orientation of the bus bar 51b (the bus bar 52b) relative to the terminal 41b (the terminal 42b) can be stabilized, and so laser welding is easy, and the quality of the weld part can be improved.

Also, as described above, the bus bar 51b (the bus bar 52b) can perform the role of a welding cover. Therefore, damage of the insulating part 31b can be suppressed. Also, the bus bar 51b (the bus bar 52b) can perform the role of a welding jig. Therefore, the welding of the bus bar 51b (the bus bar 52b) and the terminal 41b (the terminal 42b) is easy.

A method for producing the terminal 41b (the terminal 42b) will now be described.

The terminal 41b (the terminal 42b) can be formed by bending a wire-shaped member 43b into a prescribed shape.

FIG. 17 is a schematic perspective view illustrating the member 43b.

As shown in FIG. 17, the member 43b includes the conductor part 43a and the insulating part 31b. The member 43b can be formed using the wire-shaped material 101 described above. Therefore, the cross-sectional shape and the cross-sectional dimensions in a direction orthogonal to the direction in which the conductor part 43a extends can be the same as the cross-sectional shape and the cross-sectional dimensions in a direction orthogonal to the direction in which the conductor part 31a extends. The two end parts of the conductor part 43a are exposed from under the insulating part 31b.

The pair of grooves 43a2 is located in the vicinity of one end part of the conductor part 43a. The member 43 can be formed from the wire-shaped material 101 described above by providing a cutter 105e and a cutter 105f in the stripping machine 105 described above.

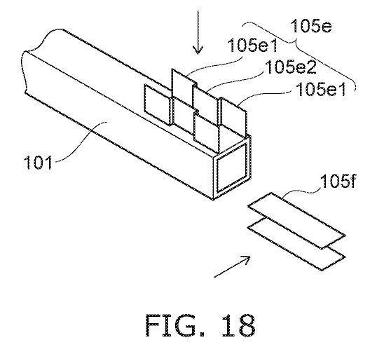

FIG. 18 is a schematic perspective view illustrating the formation of the member 43b.

As shown in FIG. 18, a pair of cutters 105e is included. The cutter 105e includes a pair of blades 105e1 that strip away the coating in a partial region of the wire-shaped material 101, and a blade 105e2 that notches a portion of the rectangular wire included in the wire-shaped material 101. The blade 105e2 is located between the blade 105e1 and the blade 105e1.

A pair of the cutters 105f is included. The cutter 105f includes a pair of blades that strip away the coating in a partial region of the wire-shaped material 101.

The movement direction of the cutter 105f is orthogonal to the movement direction of the cutter 105e. Therefore, the cutter 105e and the cutter 105f can partially strip away the coating adhered to the four side surfaces of the rectangular wire and form the pair of grooves 43a2 in the rectangular wire.

The coating that is adhered to the portion of the other end part of the member 43b (the portion to which the coil 3 is welded) may be stripped away by the cutters 105a and 105b described above.

The cutter 105a and the cutter 105b can be provided in the same stripping machine 105 as the cutters 105e and 105f, or can be provided in a different stripping machine 105.

The wire-shaped material 101 in which the pair of grooves 43a2 is formed and the coating is partially stripped away is cut to a prescribed length by the cutting machine 106 described above. The member 43b illustrated in FIG. 17 is formed by cutting such a wire-shaped material 101. The terminal 41b (the terminal 42b) can be formed by bending the wire-shaped member 43b into a prescribed shape.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions, and are within the scope of the inventions described in the claims and their equivalents. Also, the embodiments above can be implemented in combination with each other.

What is claimed is:

1. Method for producing a rotary electrical machine, comprising:
disposing a segment in each of a plurality of slots located in a core, the segment including a first conductor part and a first insulating part, the first insulating part being located at an outer surface of the first conductor part;
disposing a terminal at the core, the terminal including a second conductor part and a second insulating part, the second insulating part being located at an outer surface of the second conductor part;
forming a coil located in the slots by laser-welding end parts of an adjacent pair of the first conductor parts; and
laser-welding a bus bar to an end part of the second conductor part, the bus bar being plate-shaped,
the bus bar having a hole extending through the bus bar in a thickness direction,
the laser-welding of the bus bar including inserting the end part of the second conductor part into the hole of the bus bar.

2. The method for producing the rotary electrical machine according to claim 1, wherein
a stepped part is formed in the end part of the second conductor part, and
the laser-welding of the bus bar includes:
inserting the end part of the second conductor part into the hole of the bus bar so that the stepped part protrudes from the bus bar; and
irradiating a laser light on an end part of the stepped part.

3. The method for producing the rotary electrical machine according to claim 1, wherein
the hole of the bus bar also is open at one side of the bus bar,
a pair of grooves is located proximate to the end part of the second conductor part, and
the laser-welding of the bus bar includes:
inserting a portion of the second conductor part at which the pair of grooves is located into the hole of the bus bar from the one side; and
irradiating a laser light on the end part of the second conductor part protruding from the bus bar.

4. The method for producing the rotary electrical machine according to claim 1, wherein
the laser-welding of the bus bar includes:
disposing a welding consumable at an opening of the hole of the bus bar at a side opposite to a side from which the end part of the second conductor part is inserted, the welding consumable being pea-shaped; and
irradiating a laser light on the welding consumable.

5. A rotary electrical machine, comprising:
a coil located in a core;
a terminal located at the core, the terminal being electrically connected to the coil; and
a bus bar welded to an end part of the terminal, the bus bar being plate-shaped and having a hole extending through the bus bar in a thickness direction,
the end part of the terminal being located in the hole in the bus bar.
